(19) United States
(12) Patent Application Publication
(10) Pub. No.: US 2016/0274638 A1
(43) Pub. Date: Sep. 22, 2016

(54) DISTRIBUTED SHARED POWER APPARATUS IN DATA CENTER AND METHOD THEREOF

(71) Applicant: Electronics and Telecommunications Research Institute, Daejeon (KR)

(72) Inventor: Won Ok KWON, Daejeon-si (KR)

(21) Appl. No.: 15/073,086

(22) Filed: Mar. 17, 2016

(30) Foreign Application Priority Data
Mar. 20, 2015 (KR) 10-2015-0039097

(51) Int. Cl. G06F 1/28; G06F 11/20; H04L 12/24

(52) U.S. Cl. CPC G06F 1/28; H04L 41/12; H04L 41/0668; G06F 11/2015; G06F 2201/85

(57) ABSTRACT

A distributed shared power apparatus of a data center includes a server monitor configured to monitor two or more rack mount servers that generate power by converting incoming alternating current (AC) power into direct current (DC) power and share the generated power with each other, and to collect an available total DC power of each rack mount server and a peak DC power used by each rack mount server; and a sharing controller configured to calculate surplus DC power possessed by each rack based on the collected available total DC power of each rack mount server and the peak DC power used by each rack mount server, and to control power sharing between the two or more rack mount servers based on the calculated surplus DC power of each rack.

### CROSS-REFERENCE TO RELATED APPLICATION(S)

This application claims priority from Korean Patent Application No. 10-2015-0039097, filed on Mar. 20, 2015 in the Korean Intellectual Property Office, the disclosure of which is incorporated herein by reference in its entirety.

### BACKGROUND

1. Field

The following description relates to a power system of a data center, and more particularly, to a distributed DC power system of a data center.

2. Description of Related Art

Generally, computers, rack mount servers, and communication devices, which are mainly used in a data center, are equipped with their own power supply units (PSU) to convert received alternating current (AC) power into direct current (DC) power for use. A costly server or an essential server may have a redundant PSU additionally installed therein, in case of any failure in an existing PSU, thereby ensuring a stable power supply. Accordingly, a data center has more PSUs than actually needed, which may increase the installation cost and cause problems related to power supply stability, power supply management, and so on. To address the aforesaid problems, U.S. Patent Application publication No. US20090254768 discloses a technology for increasing power efficiency by controlling the number of PSUs to be operated, according to the load. Said US patent application may increase the power efficiency by controlling the number of running PSUs, but, for the power supply stability, still requires more PSUs than are actually needed. Hence, said technology cannot substantially resolve the relevant problems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a distributed shared power apparatus of a data center, including: a server monitor configured to monitor two or more rack mount servers that generate power by converting incoming alternating current (AC) power into direct current (DC) power and share the generated power with each other, and to collect an available total DC power of each rack mount server and a peak DC power used by each rack mount server; and a sharing controller configured to calculate surplus DC power possessed by each rack based on the collected available total DC power of each rack mount server and the peak DC power used by each rack mount server, and to control power sharing between the two or more rack mount servers based on the calculated surplus DC power of each rack.

The sharing controller may identify other rack mount servers that are in close proximity with a rack mount server that is experiencing a power failure, based on a power connectivity topology that represents power connections among the two or more rack mount servers, and resolve the power failure by supplying any surplus DC power of the identified rack mount servers to the rack mount server experiencing power failure. When the surplus DC power of the identified rack mount servers is insufficient to resolve the power failure of the rack mount server, the sharing controller may re-form the power connectivity topology by adding a connection topology to the rack mount server that is experiencing power failure. The sharing controller may form the power connectivity topology that represents power connections among the rack mount servers, based on the available total DC power of each rack mount server.

In another general aspect, there is provided a rack mount server including: one or more power-sharing servers, each comprising a power supply unit (PSU) configured to convert incoming alternating current (AC) power and generate direct current (DC) power; a power bus bar configured to receive power output from the one or more power-sharing servers and transfer the received power to another rack mount server; and a sharing server manager configured to collect power information of each PSU via the power bus bar and transmit the collected power information to a distributed shared power apparatus of a data center, and to transfer power output from the PSU to another rack mount server via the power bus bar according to power control of the distributed shared power apparatus.

The PSU may generate power by converting incoming AC power into DC power, and transfer the generated power to a main board and the power bus bar.

In yet another general aspect, there is provided a method for distributing and sharing power, which is performed by a data center, the method including: monitoring two or more rack mount servers that generate power by converting incoming alternating current (AC) power into direct current (DC) power and share the generated power with each other; collecting an available total DC power of each rack mount server and a peak DC power used by each rack mount server; calculating surplus DC power possessed by each rack based on the collected available total DC power of each rack mount server and the peak DC power used by each rack mount server; and controlling power sharing between the two or more rack mount servers based on the calculated surplus DC power of each rack.

The control of the power sharing may include identifying other rack mount servers that are in close proximity with a rack mount server that is experiencing a power failure, based on a power connectivity topology that represents power connections among the two or more rack mount servers, and resolving the power failure by supplying any surplus DC power of the identified rack mount servers to the rack mount server experiencing power failure. The control of the power sharing may include, when the surplus DC power of the identified rack mount servers is insufficient to resolve the power failure of the rack mount server, re-forming the power connectivity topology by adding a connection topology to the rack mount server that is experiencing power failure.

Other features and aspects will be apparent from the following detailed description, the drawings, and the claims.

### BRIEF DESCRIPTION OF THE DRAWINGS

FIG. 1 is a diagram illustrating an example of a distributed shared power apparatus of a data center and rack mount servers according to an exemplary embodiment.

FIG. 2 is a diagram illustrating a rack mount server according to an exemplary embodiment.

FIG. 3 is a flowchart illustrating power sharing process of a distributed shared power apparatus of a data center according to an exemplary embodiment.

FIG. 4 is a diagram for explaining a power sharing process of a distributed shared power apparatus of a data center according to an exemplary embodiment.

FIG. 5 is a diagram for explaining a power management algorithm of a distributed shared power apparatus of a data center according to an exemplary embodiment.

FIG. 6 is a flowchart illustrating a method for distributing and sharing power of a data center according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

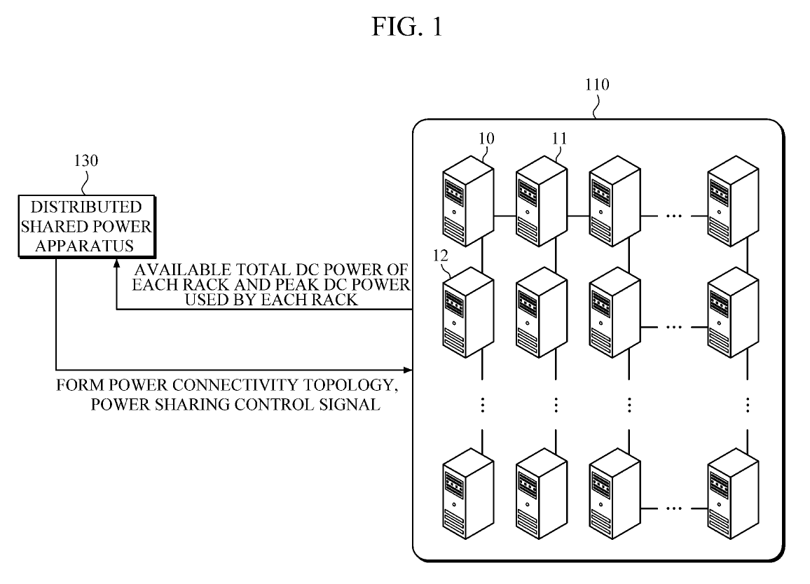

FIG. 1 is a diagram illustrating an example of a distributed shared power apparatus of a data center and rack mount servers according to an exemplary embodiment.

Referring to FIG. 1, an apparatus 130 for sharing power of a data center shares power with rack mount servers in a distributed manner, such that the power of a rack mount server in which a failure has occurred can be recovered.

Each of the rack mount servers 110 has two or more power-sharing servers mounted on a rack. The power-sharing servers each have a power supply unit (PSU) to generate power. The PSU of each power-sharing server converts current from an external source into direct current (DC) power, and supplies the DC power to the power-sharing server. Also, power from the PSU may be shared with other power-sharing servers or with other rack mount servers 110 via power bus bars. Each of the rack mount servers 110 monitors two or more power-sharing servers to identify a peak DC power actually used by each of the power-sharing servers, as well as the availability of the PSUs and their power. Then, the rack mount server 110 transmits to the apparatus 130 information about an available total DC power in each rack and a peak DC power actually used by each rack.

The apparatus 130 forms a power connectivity topology of two or more rack mount servers 110. The power connectivity topology represents the power connections among two or more rack mount servers. In the power connectivity topology, each rack mount server 110 is assumed as being a node of the topology, and the power from the rack mount server 110 is assumed as being a signal traveling between the nodes. The apparatus 130 forms the power connectivity topology consisting of rack mount servers 110 based on information received from two or more rack mount servers 110 regarding the states of each PSU and the available power and peak power used in each rack mount server 110. In the exemplary embodiment shown in FIG. 1, the apparatus 130 forms a mesh topology consisting of two or more rack mount servers 110; however, the shape of power connectivity topology is not limited thereto, and may vary according to power condition, disposition of rack mount servers, or a structure of data center. The apparatus 130 may form a power connectivity topology with a variety of shapes, allowing two or more rack mount servers 110 to share power therewith.

The apparatus 130 calculates the surplus DC power of each rack based on information received from each rack mount server 110 regarding the available total DC power in each rack and a peak DC power actually used in each rack. The available power of each rack refers to an amount of power output (generated) from one rack mount server 110, i.e., an amount of power output from all PSUs in two or more power-sharing servers of the same rack mount server 110. The maximum power consumption of each rack refers to an amount of power required to run all power-sharing servers included in one rack mount server 110. It is the difference between the available power of each rack and the maximum power consumption of each rack that is deemed as the surplus DC power of each rack in each rack mount server and is calculated by the apparatus 130.

Also, the apparatus 130 provides rack-level power sharing functionality based on the calculated surplus DC power of each rack and the power connectivity topology, such that failover can be performed for a rack mount server 110 experiencing a power failure. When a rack mount server 110 has a power failure, the apparatus 130 identifies other rack mount servers that are in close proximity with said failed server, calculates surplus DC power possessed by each rack in other rack mount servers, and then transmits any surplus DC power of the identified rack mount servers 110 to the rack mount server 110 that is experiencing power failure.

For example, the apparatus 130 may monitor two or more rack mount servers 110 and detects a power failure of one rack mount server (e.g., rack mount server 10). A power failure occurs when power supply to power-sharing servers of a rack mount server is insufficient due to a defect or fault of a PSU of said rack mount server or a lack of PSUs. When a failed rack mount server 10 is identified, the apparatus 130 checks surplus DC power of rack mount servers 11 and 12 close to said rack mount server 10 according to the power connectivity topology. The apparatus 130 transmits the surplus DC power of the nearby rack mount server 11 and 12 to the failed rack mount server 10, thereby resolving the power failure.

As such, the power output from each of power-sharing servers is shared between the rack mount servers, serving as a supplementary power source in addition to the main DC power supply, and hence a more stable power supply is possible.

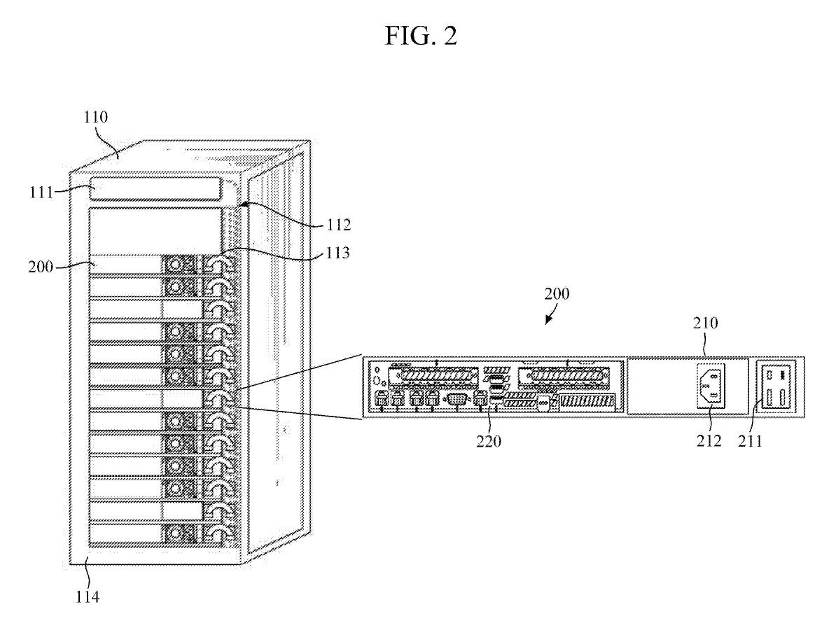

FIG. 2 is a diagram illustrating a rack mount server according to an exemplary embodiment.

Referring to FIGS. 1 and 2, the rack mount server 110 includes two or more power-sharing servers 200, a sharing server manager 111, and a power bus bar 112. The sharing server manager 210 monitors the states of the power-sharing servers 200, and checks the maximum power consumption of the two or more power-sharing servers 200 and the available power output from said power-sharing servers 200, transmitting the relevant information to a distributed shared power apparatus 130 of a data center. The sharing server manager 111 transmits power output from the power-sharing server 200 and shares the power with a different rack mount server 110 based on a power-sharing control signal of the apparatus 130.

The power bus bar 112 is connected to a power output portion 211 of a PSU 210 of each power-sharing server 200. The power output portion 210 of the power-sharing server 200 is connected to the power bus bar 112 via a link cable 113, through which the power bus bar 111 is supplied with power from the power-sharing server 200. The power bus bar 111 mounted in one rack mount server 110 may be connected to a power bus bar of another rack mount server, whereby the rack mount servers can transmit and receive power therebetween. The link cable 113 for connecting the power bus bar 112 and the power-sharing server 200 and a cable for connecting the power bus bars 112 of different rack mount servers 110 with each other are both flexible, whereby said cables are firmly coupled to the relevant components, and may be formed to standard, thus making them suitable for transferring the power from the power output portion 211.

The power-sharing server 200 is detachably connected to a rack 114 and secured in position. The rack 114 has a structure in which a plurality of power-sharing servers 200 can be securely arranged.

The power-sharing server 200 includes a PSU 210 and a main board 220. The PSU 210 is supplied with current from an external source and converts the received current into DC power. Generally, servers in a data center convert supplied alternating current into DC power. DC power converted in the PSU 210 is transferred to the main board 220 to run the power-sharing server 200. Also, the DC power from the PSU 210 is relayed to the power bus bar 112 via the power-output portion 211, and then is transferred to and shared with another rack mount server 110.

For example, the PSU 210 may input or output a power signal, an independent signal, a shared signal, or the like. The power signal may include a DC output voltage (VDD), a standby voltage (V_{SB}), a ground signal (GND) and the like; and the independent signal may include a power on/off signal (PSON), a reset signal (RST), and a power state signal (PSOK) and so on. The shared signal may include a load shared signal of PSU 210 and a power management signal, such as a power management BUS (PMBUS).

A power backplane board may be installed between the PSU 210 and the main board 220. A ventilation fan may be installed on a rear side of the PSU 210. Also, an interface may be provided to the power-output portion 211, allowing the input or output of the DC output voltage, the ground signal, the standby voltage, and the shared signal.

The main board 220 may take on the role of a server, being connected to the PSU 210 to be supplied with DC power to operate. The power supplied from the PSU 210 may enable the main board 220 to control multiple devices (components).

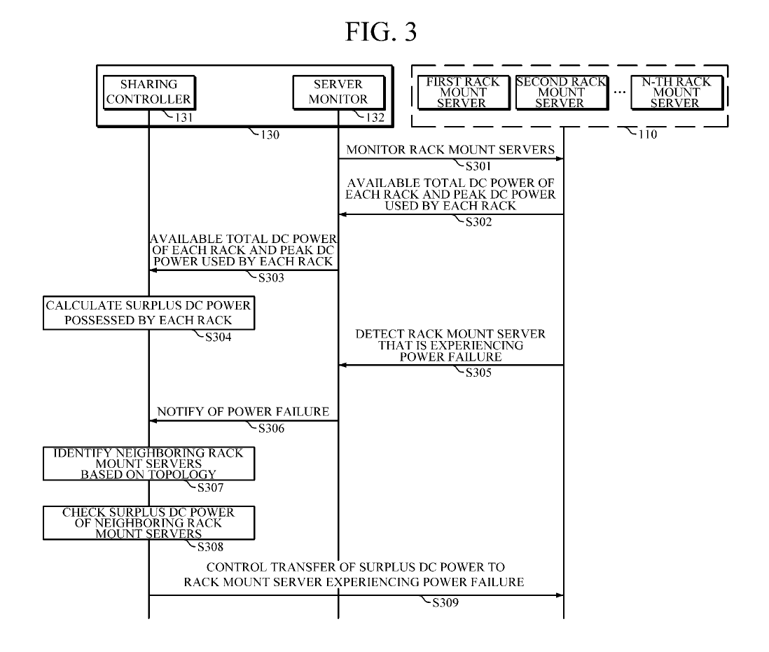

FIG. 3 is a flowchart illustrating a power sharing process of a distributed shared power apparatus of a data center according to an exemplary embodiment.

Referring to FIGS. 1 and 3, the apparatus 130 includes a sharing controller 131 and a server monitor 132. The server monitor 132 constantly monitors the two or more rack mount servers 110, as depicted in S301. The server monitor 132 monitors each of the rack mount servers 110 that form the power connectivity topology, and collects information about available total DC power (Pt) in each rack and peak DC power (Pc) actually used in each rack, as depicted in S302. The server monitor 132 may measure the available DC power in each rack mount server 110 and the peak DC power used by each rack mount server 110 by use of a power management signal, such as power management bus (PMBUS), or a PSU communication signal. In addition to the aforesaid signals, the server monitor 132 may use various methods to measure the available DC power and the peak DC power used. Then, the server monitor 132 sends the collected information regarding Pt and Pc to the sharing controller 131, as depicted in S303.

When the sharing controller 131 receives the information regarding the available total DC power in each rack and the peak DC power actually used in each rack from the server monitor 132, the sharing controller 131 calculates a surplus DC power in each rack, which is a value corresponding to a difference between the available total DC power in each rack and the peak DC power actually used in each rack, as depicted in S304. The surplus DC power in a rack indicates an amount of DC power remaining after use by the rack mount servers 110 in said rack. Generally, the available DC power in a rack is designed to be greater than the peak DC power actually used in said rack, and so the difference between the available DC power and the peak DC power actually used can be calculated to obtain the amount of surplus DC power. If said difference between the peak DC power and the available DC power is immediately deemed as surplus DC power, this may destabilize the power that is being input. Therefore, the surplus DC power may be set to be smaller than the actual difference between the available DC power and the peak DC power used, and so a certain DC power margin may occur. That is, the surplus DC power may be obtained by subtracting the peak DC power used immediately from the available DC power, or by subtracting both the peak DC power used and the DC power margin from the available DC power. The DC power margin used in calculating the surplus DC power may vary according to the rack mount servers 110.

During monitoring, if the server monitor 132 detects a rack mount server in which a power failure has occurred, as depicted in S305, the server monitor 132 notifies the sharing controller 131 of the power failure, as depicted in S306. The power failure in a rack mount server occurs when power supply to power-sharing servers of the rack mount server is insufficient due to the defect or fault of a PSU of said rack mount server or the lack of PSUs.

In response to the notification of power failure from the server monitor 132, the sharing controller 131 identifies rack mount servers in proximity with the rack mount server 110 experiencing a power failure, based on a power connectivity topology, as depicted in S307. The power connectivity topology consists of two or more rack mount servers 110 and is formed in a predesignated topology shape. The sharing controller 131 may identify one or more rack mount servers that are near said failed rack mount server, based on the power connectivity topology. The nearby rack mount servers may be ones that are connected to the failed rack mount server through power cables.

Once the rack mount servers near the failed rack mount server have been identified, the sharing controller 131 checks the surplus DC power of each of the identified rack mount servers, as depicted in S308, and controls said identified rack mount servers to transfer the surplus DC power to the failed rack mount server, as depicted in S309. The rack mount server in which a power failure has occurred due to an error or a lack of PSUs cannot operate normally. However, the distributed shared power apparatus 130 of a data center according to the present disclosure forms the power connectivity topology, allowing the rack mount servers to share their surplus DC powers. If the power failure cannot be recovered based on the surplus DC power from the identified rack mount servers nearby the failed rack mount server, i.e., if the surplus DC powers of the nearby rack mount servers are not sufficient to supply the failed rack mount server, the sharing controller 131 re-forms the power connectivity topology and performs operations S307 to S309 again to share surplus DC powers.

As such, surplus DC powers of nearby rack mount servers are transferred to a failed rack mount server, and thereby a failover is possible. In addition, since failover is performed by sharing the surplus DC powers of nearby rack mount servers, a redundant power supply unit that would conventionally be provided in case of power failure is not needed.

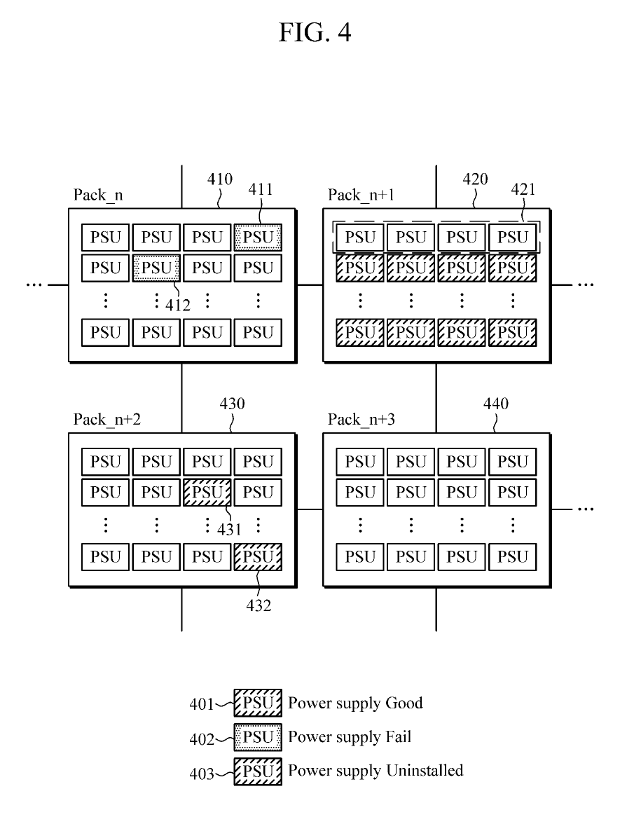

FIG. 4 is a diagram for explaining a power sharing process of a distributed shared power apparatus of a data center according to an exemplary embodiment.

Referring to FIGS. 1 and 4, the exemplary embodiment of FIG. 4 represents a power sharing process of a plurality of rack mount servers 110 arranged in a mesh topology. For convenience of explanation, in FIG. 4, the power-sharing servers constituting the rack mount server 110 are simplified as PSUs that actually output DC power. Also, the states of a PSU include normal state (“POWER SUPPLY GOOD”) 401, erroneous state (“POWER SUPPLY FAIL”) 402, and uninstalled state (“POWER SUPPLY UNINSTALLED”) 403. The n-th rack mount server 410 has two erroneous PSUs 411 and 412. In this case, failover is possible by sharing DC power within the n-th rack mount server 410.

The (n+1)-th rack mount server 420 has only four PSUs 421 which are uninstalled. Thus, the (n+1)-th rack mount server 420 may experience power supply shortage. The distributed shared power apparatus 130 of a data center checks the states of rack mount servers in proximity with the (n+1)-th rack mount server 420 based on the power connectivity topology, in order to resolve the lack of power supply. The n-th rack mount server 410 and the (n+3)-th rack mount server 440 are in proximity with the (n+1)-th rack mount server 420. The distributed shared power apparatus 130 transfers the surplus DC powers of both the n-th and (n+3)-th rack mount servers 410 and 440 to the (n+1)-th rack mount server 420 via the power supply connection, thereby balancing the power supply shortage of the (n+1)-th rack mount server 420.

The (n+2)-th rack mount server 430 has two uninstalled PSUs 431 and 432, for which failover can be performed by sharing DC power within the (n+2)-th rack mount server 430, in the same manner as in the n-th rack mount server 410. The (n+3)-th rack mount server 440 has PSUs that all operate normally, and it serves as a power supplying rack capable of transferring its surplus DC power to the nearby rack mount servers.

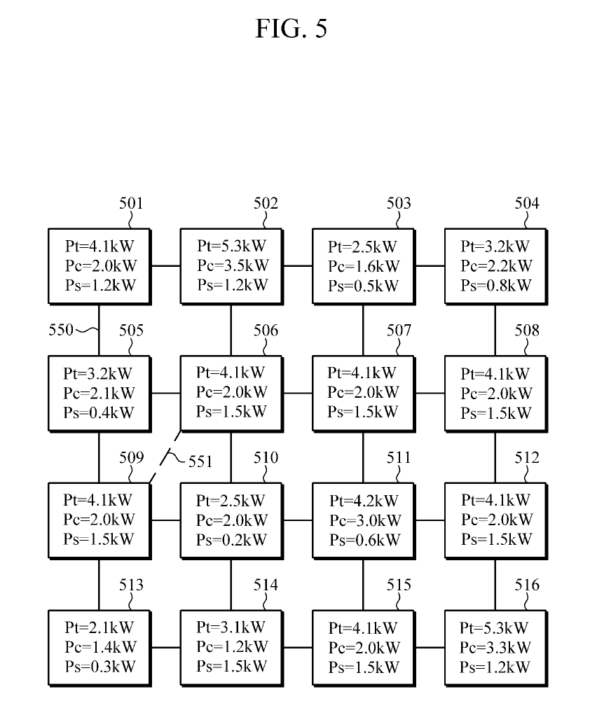

FIG. 5 is a diagram for explaining a power management algorithm of a distributed shared power apparatus of a data center according to an exemplary embodiment.

Referring to FIG. 5, a distributed shared power apparatus includes a total of 16 rack mount servers 501 to 516 which are connected in a mesh topology. The distributed shared power apparatus may control power supply to the rack mount servers by turning on/off power supply connection between the rack mount servers. In FIG. 5, Pt denotes an available total DC power in each rack, Pc denotes a peak DC power actually used in each rack, and Ps denotes a surplus DC power in each rack. The exemplary of FIG. 5 assumes that a surplus DC power is set to be smaller than a difference between the available total DC power and the peak DC power actually used, such that the surplus DC power can have a DC power margin of a designated value for the sake of power supply stability, and DC power margins are set to be different among the racks.

Referring to FIG. 5, the second rack mount server 502 on the top has an available total DC power of 5.3 kW, and a surplus DC power of 1.2 kW, and has used a peak power of 3.5 kW. If a power failure occurs in the second rack mount server 502, a power of 3.5 kW, which corresponds to the peak power used by the second rack mount server 502, has to be supplied to said rack mount server 502. Surplus DC powers of rack mount servers 501, 503, and 506 in proximity with the second rack mount server 502 are 1.5 kW, 0.5 kW, and 1.5 kW, respectively, and a total of 3.5 kW of surplus DC power can be transferred to the failed rack mount server 502. That is, the peak DC power used by the second rack mount server 502 is equal to the sum of surplus DC powers (3.5 kW) of the neighboring rack mount servers 501, 503, and 506, and hence, stable supply of surplus DC power to the second rack mount server 502 is possible.

On the contrary, the ninth rack mount server 509, counting from the left to the right, has an available total DC power of 4.1 kW, a surplus DC power of 1.5 kW, and has used a peak power of 2.0 kW. In the case of a power failure occurs in the ninth rack mount server 509, a DC power of 2.0 kW that corresponds to the peak DC power used by said ninth rack mount server 509 has to be supplied to said server 509. Surplus DC powers of rack mount servers 505, 510, and 513 that are in proximity with the ninth rack mount server 509 are 0.4 kW, 0.2 kW, and 0.3 kW, respectively, and hence a total of 0.9 kW can be transferred to the ninth rack mount server 509. Since the peak DC power actually used by the ninth rack mount server 509 is 2.0 kW whereas the sum of surplus DC powers available from the neighboring rack mount servers 505, 510, and 513 is only 0.9 kW, it is not possible to perform failover of the failed rack mount server 509 with the surplus DC powers supplied from the nearby rack mount servers 505, 510, and 513. In this case, to enable the failover of the ninth rack mount server 509, the distributed shared power apparatus 130 may form an additional connection topology 551 between the sixth rack mount server 506 that has a surplus DC power of 1.5 kW and the ninth rack mount server 509, such that a sum of surplus powers from the neighboring rack mount servers of the failed rack mount server 509 is 2.4 kW.

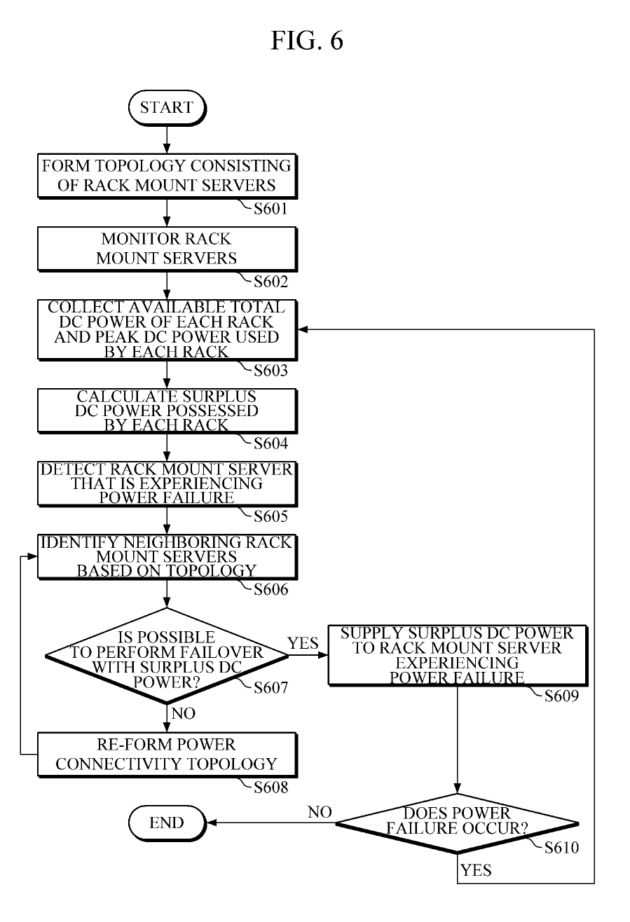

FIG. 6 is a flowchart illustrating a method for distributing and sharing power of a data center according to an exemplary embodiment.

Referring to FIG. 6, a method for distributing and sharing power using a distributed shared power apparatus of a data center begins with the apparatus's forming a power connectivity topology consisting of two or more rack mount servers, as depicted in S601. The two or more rack mount servers may share generated power with one another. Hence, the apparatus forms the power connectivity topology to allow the power sharing among the two or more rack mount servers that are connected to each other. Said apparatus of a data center may form the power connectivity topology based on an available total DC power in each rack mount server and a peak DC power used by each rack mount server. The power connectivity topology is not limited to a specific shape, and may vary according to a structure of the data center or the power generated. Forming of the power connectivity topology may be only performed when no topology has been created, or when there is a user's request.

Then, rack mount servers in the power connectivity topology are monitored, as depicted in S602. By doing so, the distributed shared power apparatus collects information about each of the rack mount servers included in the power connectivity topology, regarding an available total DC power in each rack and a peak DC power actually used by each rack, as depicted in S603. Said apparatus may measure the available DC power in each rack mount server and the peak DC power used by each rack mount server by use of a power management signal, such as power management bus (PMBUS), or a PSU communication signal. In addition to the aforesaid signals, the apparatus may use various methods to measure said DC power.

A surplus DC power in each rack is calculated based on the information collected in S604 about the available DC power and the peak DC power, as depicted in S604. When receiving information regarding the available total DC power in each rack and the peak DC power actually used by each rack, the distributed shared power apparatus calculates the surplus DC power in each rack based on a difference between the available total DC power and the peak DC power used. Generally, the available total DC power of each rack is set to be much greater than the peak DC power used by each rack, and the surplus DC power of each rack may be set to be smaller than a difference between said available total DC power and peak DC power used, such that the surplus DC power would have a DC power margin that is adequate enough for maintaining the stability of the power supply.

If a rack mount server with a power failure has been detected, as depicted in S605, while monitoring the rack mount servers, the apparatus checks for any surplus DC powers in rack mount servers that are in close proximity with the rack mount server experiencing a power failure, as depicted in S606. In other words, the apparatus may identify the rack mount servers that are close to said failed rack mount server, and check for any surplus DC powers in the identified rack mount servers. Then, the apparatus compares a sum of the checked surplus DC powers with an amount of power required by the failed rack mount server, and determines whether failover can be performed with the surplus DC powers, as depicted in S607. The amount of power required by the failed rack mount server may be equal to the peak DC power used by the failed rack mount server or a difference between the peak DC power used and a currently generated DC power.

When it is determined in S607 that failover cannot be performed based on the current power connectivity topology, the apparatus re-forms the power connectivity topology, as depicted in S608. If a sum of surplus DC powers from the rack mount servers adjacent to the failed rack mount server is not sufficient to initiate failover, the apparatus adds a surplus DC power of a nearby rack mount server by adding a connection topology to the current power connectivity topology. Then, the apparatus performs operations S606 and S607 again to determine whether failover can be performed.

When it is determined in S607 that failover of the failed rack mount server can be performed with any surplus DC power from the adjacent rack mount servers, the apparatus supplies the surplus DC power of the adjacent rack mount servers to the rack mount server experiencing a power failure, as depicted in S609. Thereafter, the apparatus confirms whether a power failure has occurred again in the rack mount server that has experienced a power failure, as depicted in S609; if the power failure has not been resolved, the flows returns to S603 where the information about an available total DC power of each rack and a peak DC power used by each rack.

According to the exemplary embodiments, a distributed shared power apparatus and the method thereof allow the power generated by a PSU to be shared within a rack mount server, and allows the power to be distributed and shared among rack mount servers, so that failover of a particular rack mount server experiencing a power failure is possible without a redundant PSU. In what would be considered a conventional data center, if even one rack out of plurality of racks in a rack mount server that supports power supply redundancy is experiencing a power failure, failover is not possible without replacing a PSU. However, according to the exemplary embodiments, it is possible to recover the power failure using the surplus DC power of other rack mount servers close to a rack mount server experiencing a power failure, without having to replace a PSU.

The current embodiments can be implemented as computer readable codes in a computer readable record medium. Codes and code segments constituting the computer program can be easily inferred by a skilled computer programmer in the art. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A distributed shared power apparatus of a data center, comprising:
a server monitor configured to monitor two or more rack mount servers that generate power by converting incoming alternating current (AC) power into direct current (DC) power and share the generated power with each other, and to collect an available total DC power of each rack mount server and a peak DC power used by each rack mount server; and
a sharing controller configured to calculate surplus DC power possessed by each rack based on the collected available total DC power of each rack mount server and the peak DC power used by each rack mount server, and to control power sharing between the two or more rack mount servers based on the calculated surplus DC power of each rack.

2. The distributed shared power apparatus of claim 1, wherein the sharing controller identifies other rack mount servers that are in close proximity with a rack mount server that is experiencing a power failure, based on a power connectivity topology that represents power connections among the two or more rack mount servers, and resolves the power failure by supplying any surplus DC power of the identified rack mount servers to the rack mount server experiencing power failure.

3. The distributed shared power apparatus of claim 2, wherein, when the surplus DC power of the identified rack mount servers is insufficient to resolve the power failure of the rack mount server, the sharing controller re-forms the power connectivity topology by adding a connection topology to the rack mount server that is experiencing power failure.

4. The distributed shared power apparatus of claim 1, wherein the sharing controller forms the power connectivity topology that represents power connections among the rack mount servers, based on the available total DC power of each rack mount server.

5. The distributed shared power apparatus of claim 1, wherein the server monitor measures the available total DC power of each rack mount server and the peak DC power used by each rack mount server by use of power management signals or power supply unit (PSU) communication signals.

6. A rack mount server comprising:
one or more power-sharing servers, each comprising a power supply unit (PSU) configured to convert incoming alternating current (AC) power and generate direct current (DC) power;
a power bus bar configured to receive power output from the one or more power-sharing servers and transfer the received power to another rack mount server; and
a sharing server manager configured to collect power information of each PSU via the power bus bar and transmit the collected power information to a distributed shared power apparatus of a data center, and to transfer power output from the PSU to another rack mount server via the power bus bar according to power control of the distributed shared power apparatus.

7. The rack mount server of claim 6, wherein the PSU generates power by converting incoming AC power into DC power, and transfers the generated power to a main board and the power bus bar.

8. The rack mount server of claim 6, wherein when a different rack mount server is experiencing power failure, the sharing server manager resolves the power failure by transferring surplus DC power to the rack mount server that is experiencing power failure, according to control of the distributed shared power apparatus of a data center.

9. A method for distributing and sharing power, which is performed by a data center, the method comprising:
monitoring two or more rack mount servers that generate power by converting incoming alternating current (AC) power into direct current (DC) power and share the generated power with each other;
collecting an available total DC power of each rack mount server and a peak DC power used by each rack mount server;
calculating surplus DC power possessed by each rack based on the collected available total DC power of each rack mount server and the peak DC power used by each rack mount server; and
controlling power sharing between the two or more rack mount servers based on the calculated surplus DC power of each rack.

10. The method of claim 9, wherein the control of the power sharing comprises identifying other rack mount servers that are in close proximity with a rack mount server that is experiencing a power failure, based on a power connectivity topology that represents power connections among the two or more rack mount servers, and resolving the power failure by supplying any surplus DC power of the identified rack mount servers to the rack mount server experiencing power failure

11. The method of claim 10, wherein the control of the power sharing comprises, when the surplus DC power of the identified rack mount servers is insufficient to resolve the power failure of the rack mount server, re-forming the power connectivity topology by adding a connection topology to the rack mount server that is experiencing power failure.

12. The method of claim 9, wherein the power connectivity topology that represents power connections among the rack mount servers is formed based on the available total DC power of each rack mount server.

13. The method of claim 9, wherein the monitoring of the two or more rack mount servers comprises measuring the available total DC power of each rack mount server and the peak DC power used by each rack mount server by use of power management signals or power supply unit (PSU) communication signals.
